(19) United States
(12) Patent Application Publication
(10) Pub. No.: US 2022/0141625 A1
(43) Pub. Date: May 5, 2022

(54) CLUSTER HEAD PARAMETER DETERMINATION METHOD AND TERMINAL

(71) Applicant: NTT DOCOMO, INC., Tokyo (JP)

(72) Inventors: Yanru Wang, Beijing (CN); Xiaolin Hou, Beijing (CN); Lan Chen, Beijing (CN); Anxin Li, Beijing (CN)

(73) Assignee: NTT DOCOMO, INC., Tokyo (JP)

(21) Appl. No.: 17/433,791

(22) PCT Filed: Apr. 4, 2019
(86) PCT No.: PCT/CN2019/081453

§ 371 Date: Aug. 25, 2021

(51) Int. Cl. H04W 4/06; H04W 4/02; H04W 8/00; H04W 4/46

(52) U.S. Cl. CPC H04W 4/06; H04W 4/023; H04W 92/18; H04W 4/46; H04W 8/005

(57) ABSTRACT

Provided are a cluster head parameter determination method and a terminal. The terminal includes: a processing unit for determining a cluster head parameter according to link state information of links between the terminal and neighboring terminals, and mobile information of at least some of the neighboring terminals; and a sending unit for sending information of the cluster head parameter.

### TECHNICAL FIELD

The present disclosure relates to a field of wireless communication, and more particularly, to a method for determining cluster head parameters and a terminal.

### BACKGROUND

In Internet of Vehicles technology such as V2X (vehicle to everything), it is proposed to cluster terminals (for example, vehicles) to facilitate scheduling. Each cluster includes a cluster head of the cluster and members (that is, terminals in the cluster other than the cluster head) of the cluster. The cluster head may be used, for example, to deliver control information to the members. At present, a variety of methods for determining a cluster head have been proposed in the V2X technology. For example, an ID-based cluster head determination method is proposed, that is, a terminal with the lowest ID among terminals divided into one cluster is determined as the cluster head. As another example, a location-based cluster head determination method is proposed, that is, a terminal located in the center among terminals divided into one cluster is determined as the cluster head.

On the other hand, in order to further improve spectrum utilization of a communication system, it is hoped to apply millimeter waves (mmWaves) to the Internet of Vehicles technology for communication. However, due to their transmission characteristics, millimeter waves have short transmission distances and are sensitive to blockage. In other words, when millimeter waves are used for communication, the blockage will cause many links to be unavailable. However, existing cluster head determination methods of the Internet of Vehicles technology do not consider the blockage problem, which may lead to unreasonable clustering and cluster head selection when millimeter waves are applied, causing vehicles to frequently switch clusters to which they belong. Therefore, the existing cluster head determination methods of the Internet of Vehicles technology are not suitable for the situation where millimeter waves are applied to the Internet of Vehicles technology.

In addition, existing millimeter wave transmission methods are generally used in a static communication environment, where movement of devices is not considered, and grouping of devices is uniformly determined by a central management device. However, in Internet of Vehicles application scenarios, vehicles move at a high speed, and thus in the Internet of Vehicles technology, it is difficult to set up a central management device to group devices as in the static communication environment. In other words, existing grouping methods in millimeter waves are difficult to be used in the Internet of Vehicles environment.

### SUMMARY OF THE DISCLOSURE

According to an aspect of the present disclosure, a terminal is provided. The terminal comprises: a processing unit configured to determine a cluster head parameter according to link state information of links between the terminal and neighboring terminals, and movement information about at least a part of the neighboring terminals; and a transmitting unit configured to transmit information about the cluster head parameter.

According to an example of the present disclosure, the above terminal further comprises: a receiving unit configured to receive information about cluster head parameters of the neighboring terminals transmitted by the neighboring terminals. And the processing unit of the above terminal is further configured to determine whether the terminal becomes a cluster head according to the cluster head parameter determined by the processing unit and the cluster head parameters of the neighboring terminals.

According to an example of the present disclosure, the link state information may include information about unblocked links of the terminal; and the movement information may include movement information about neighboring terminals corresponding to the respective unblocked links. And according to another example of the present disclosure, the link state information may include signal state information about the respective links of the terminal; and the movement information may include movement information about neighboring terminals corresponding to the respective links.

In addition, according to an example of the present disclosure, the movement information may include relative information between the terminal and the neighboring terminals.

In addition, according to an example of the present disclosure, the transmitting unit of the above terminal is further configured to transmit cluster head information when it is determined that the terminal becomes a cluster head. And according to another example of the present disclosure, the receiving unit of the above terminal is further configured to receive cluster head information transmitted by a cluster head when the terminal does not become a cluster head; and the processing unit is further configured to determine whether to join a cluster where the cluster head is located according to movement information corresponding to the cluster head information.

According to another aspect of the present disclosure, a terminal is provided. The terminal comprises: a processing unit configured to determine whether to transmit invitation information to a newly-appearing neighboring terminal according to link state information of links between the newly-appearing neighboring terminal and members in a cluster where the terminal is located; and a transmitting unit configured to transmit the invitation information when it is determined to transmit the invitation information to the newly-appearing neighboring terminal.

According to an example of the present disclosure, the link state information includes: information about unblocked links between the newly-appearing neighboring terminal and the members of the cluster where the terminal is located, and information about blocked links between the newly-appearing neighboring terminal and the members of the cluster where the terminal is located. In addition, according to another example of the present disclosure, the link state information includes: signal state information about the links between the newly-appearing neighboring terminal and the members of the cluster where the terminal is located.

According to another aspect of the present disclosure, a method for determining cluster head parameters is provided, comprising: determining a cluster head parameter according to link state information of links between the terminal and neighboring terminals, and movement information about at least a part of the neighboring terminals; and transmitting information about the cluster head parameter.

According to an example of the present disclosure, the above method for determining cluster head parameters further comprises: receiving information about cluster head parameters of the neighboring terminals transmitted by the neighboring terminals; and determining whether the terminal becomes a cluster head according to the cluster head parameter determined by the processing unit and the cluster head parameters of the neighboring terminals.

According to an example of the present disclosure, the link state information in the above method for determining cluster head parameters may include information about unblocked links of the terminal; and the movement information may include movement information about neighboring terminals corresponding to the respective unblocked links. And according to another example of the present disclosure, the link state information in the above method for determining cluster head parameters may include signal state information about the respective links of the terminal; and the movement information may include movement information about neighboring terminals corresponding to the respective links.

In addition, according to an example of the present disclosure, the movement information in the above method for determining cluster head parameters may include relative information between the terminal and the neighboring terminals.

In addition, according to an example of the present disclosure, the above method for determining cluster head parameters may further comprise transmitting cluster head information when it is determined that the terminal becomes a cluster head. And according to another example of the present disclosure, the above method for determining cluster head parameters may further comprise receiving cluster head information transmitted by a cluster head when the terminal does not become a cluster head; and determining whether to join a cluster where the cluster head is located according to movement information corresponding to the cluster head information.

According to another aspect of the present disclosure, a member invitation method is provided, comprising: determining whether to transmit invitation information to a newly-appearing neighboring terminal according to link state information of links between the newly-appearing neighboring terminal and members of a cluster where the terminal is located; and transmitting the invitation information when it is determined to transmit the invitation information to the newly-appearing neighboring terminal.

According to an example of the present disclosure, the link state information in the above member invitation method includes: information about unblocked links between the newly-appearing neighboring terminal and the members of the cluster where the terminal is located, and information about blocked links between the newly-appearing neighboring terminal and the members of the cluster where the terminal is located. In addition, according to another example of the present disclosure, the link state information in the above member invitation method includes: signal state information about the links between the newly-appearing neighboring terminal and the members of the cluster where the terminal is located.

### BRIEF DESCRIPTION OF THE DRAWINGS

The foregoing and other objectives, features and advantages of the present disclosure will become clearer from more detailed description of embodiments of the present disclosure in conjunction with accompanying drawings. The accompanying drawings are used to provide a further understanding of the embodiments of the present disclosure, constitute a part of this specification, and help to explain the present disclosure together with the embodiments of the present disclosure, but are not intended to act as a limitation of the present disclosure. In the accompanying drawings, like reference numerals usually indicate like components or steps.

FIG. 1 is a schematic diagram of an Internet of Vehicles system in which the embodiments of the present disclosure may be applied.

FIG. 2A and FIG. 2B are schematic diagrams showing problems that may occur when millimeter waves are used in the Internet of Vehicles system shown in FIG. 1.

FIG. 3 is a schematic block diagram showing a terminal according to an embodiment of the present disclosure.

FIG. 4 is a schematic illustration showing whether a link between a terminal and a neighboring terminal is blocked.

FIG. 5 is a schematic block diagram showing a terminal according to another embodiment of the present disclosure.

FIG. 6 depicts a schematic flowchart of a method for determining cluster head parameters according to an embodiment of the present disclosure.

FIG. 7 depicts a schematic flowchart of a member invitation method according to an embodiment of the present disclosure.

FIG. 8 is a schematic diagram of a hardware structure of an involved device according to the embodiments of the present disclosure.

### DESCRIPTION OF THE EMBODIMENTS

In order to make objectives, technical solutions and advantages of the present disclosure clearer, exemplary embodiments according to the present disclosure will be described in detail below with reference to the accompanying drawings. Like reference numerals refer to like elements throughout the accompanying drawings. It should be understood that the embodiments described herein are merely illustrative and should not be constructed as limiting the scope of the present disclosure. In addition, terminals described herein may include various types of terminals, for example, User Equipment (UE), mobile terminals (or referred to as mobile stations) or vehicles configured with communication modules.

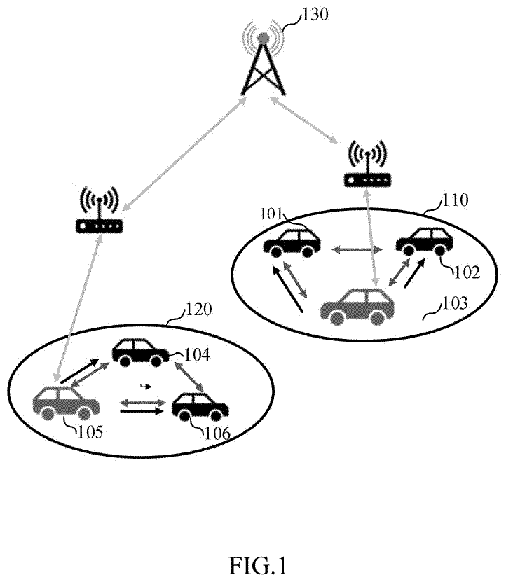

First, an Internet of Vehicles system in which the embodiments of the present disclosure may be applied will be described with reference to FIG. 1. In the example shown in FIG. 1, a V2X system is taken as an example for description. However, it should be appreciated that the following description may also be applied to other types of Internet of Vehicles systems. In addition, in the embodiments according to the present disclosure, millimeter waves are used for communication between terminals and terminals in the Internet of Vehicles system.

As shown in FIG. 1, in the Internet of Vehicles system 100, vehicles 101-106 are divided into two clusters, namely a cluster 110 and a cluster 120. A base station 130 allocates resources according to the clusters. In addition, each cluster includes a cluster head and several members (that is, vehicles in the cluster other than the cluster head). The cluster head may coordinate resource allocation within the cluster, and may transmit scheduling information or control information to the members of this cluster. The members may communicate according to the scheduling information or control information transmitted by the cluster head. For example, in the cluster 110, the vehicle 103 is the cluster head. The vehicle 103 transmits scheduling information to the member vehicles 101 and 102 of the cluster (as shown by black arrows). Vehicles 101, 102, and 103 may communicate data according to the scheduling information (as shown by darker gray arrows).

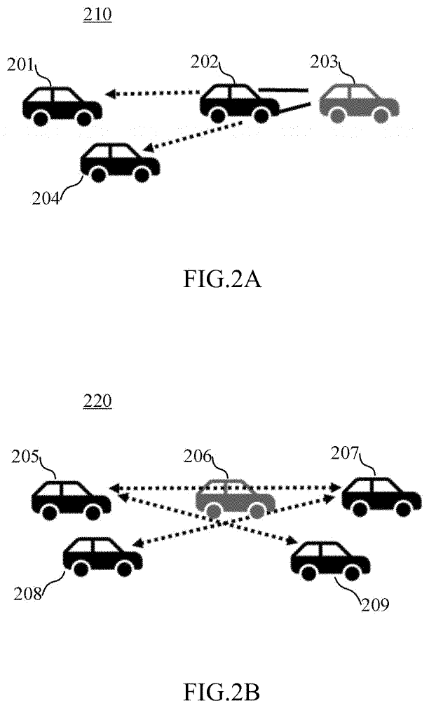

FIG. 2A and FIG. 2B are schematic diagrams showing problems that may occur when millimeter waves are used in the Internet of Vehicles system shown in FIG. 1. Due to their transmission characteristics, millimeter waves have short transmission distances and are sensitive to blockage. Unlike traditional wireless communication technology for signal transmission, when millimeter waves are used for communication, links between vehicles and vehicles cannot pass through obstacles, but will be blocked by the obstacles. In other words, when millimeter waves are used for communication, the blockage will cause many links to be unavailable.

For example, in the example shown in FIG. 2A, assuming that a cluster 210 includes vehicles 201-204, where the vehicle 203 is the cluster head and the other vehicles are members. The member 202 blocks links between the cluster head 203 and the member 201, and between the cluster head 203 and the member 204 (as shown by dashed arrows in FIG. 2A), so that the cluster head 203 cannot communicate with the member 201 and the member 204. For example, scheduling information transmitted from the cluster head 203 cannot be delivered to the member 201 and the member 204.

For example, in the example shown in FIG. 2B, assuming that a cluster 220 includes vehicles 205-209, where the vehicle 206 is the cluster head and other vehicles are members. The cluster head 206 blocks links between the member 205 and the member 207, the member 205 and the member 209, and the member 207 and the member 208 (as shown by dashed arrows in FIG. 2B), resulting in the member 205 being unable to communicate with the member 207 and the member 209, and the member 207 being unable to communicate with the member 208. Therefore, although scheduling information transmitted from the cluster head 206 can reach each member, multiple links between the members are blocked and data transmission cannot be performed.

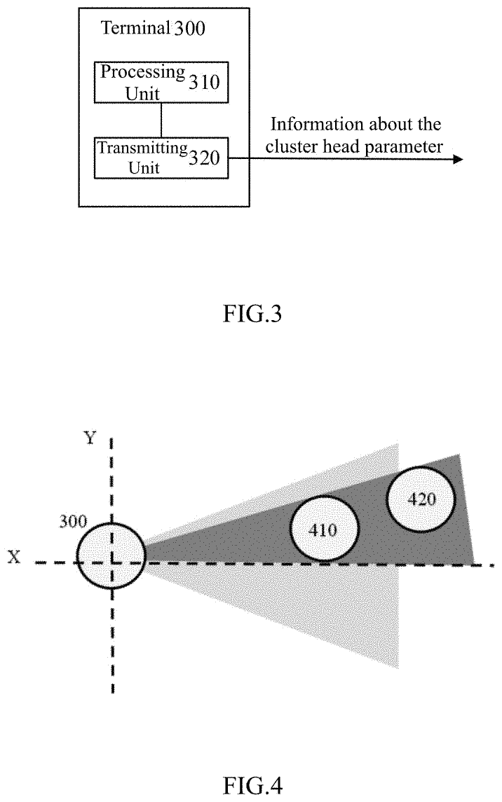

Therefore, it is desirable to propose a terminal and a method for determining cluster head parameters to improve the above situation. A terminal 300 according to an embodiment of the present disclosure will be described below with reference to FIG. 3. As shown in FIG. 3, the terminal 300 according to the embodiment of the present disclosure may include a processing unit 310 and a transmitting unit 320. In addition to the processing unit and the transmitting unit, the terminal 300 may further include other components. However, since these components are irrelevant to the content of the embodiments of the present disclosure, illustrations and descriptions thereof are omitted herein.

As shown in FIG. 3, the processing unit 310 may determine a cluster head parameter according to link state information of links between the terminal 300 and neighboring terminals, and movement information about at least a part of the neighboring terminals. Specifically, the link state information may be information indicating a connection state of the links between the terminal 300 and the neighboring terminals. For example, the link state information may be information that directly or indirectly indicates the state of the links being blocked or not being blocked. In addition, according to an example of the present disclosure, the movement information may include relative information between the terminal 300 and the neighboring terminals. For example, the movement information may include relative distances, relative speeds, relative positions and the like between the terminal 300 and the neighboring terminals. According to another example of the present disclosure, the movement information is associated with the link state information. For example, when the link state information indicates an unblocked link, the movement information may include movement information of a neighboring terminal on the unblocked link. As another example, when the link state information relates to the connection state of all links of the terminal 300, the movement information may include movement information of neighboring terminals on all the links. Examples in which the processing unit 310 determines the cluster head parameter will be further described below in conjunction with specific examples of the link state information and the movement information.

### Example 1 of Determining the Cluster Head Parameter

According to an example of the present disclosure, the link state information may include information about unblocked links of the terminal 300. For example, the processing unit 310 may first obtain blocked areas caused by the neighboring terminals, and determine the information about the unblocked links of the terminal 300 according to the blocked areas caused by the neighboring terminals. For example, a neighboring terminal that causes a blocked area of the terminal 300 is referred to as an obstacle terminal. When other neighboring terminals are located in the blocked area caused by the obstacle terminal, the processing unit 310 may determine that links between the terminal 300 and the other neighboring terminals are blocked links, and otherwise unblocked links.

In addition, in this example, each terminal may broadcast its own position information and motion information (for example, speed information, etc.). The terminal 300 may include a receiving unit to receive position information, motion information and the like transmitted by neighboring terminals. The processing unit 310 may determine blocked areas caused by the neighboring terminals and neighboring terminals located or not in the blocked areas according to the position information, motion information and the like broadcast by the neighboring terminals, so as to obtain information about the unblocked links of the terminal 300.

FIG. 4 is a schematic illustration showing whether the links between the terminal 300 and the neighboring terminals are blocked. In the example shown in FIG. 4, it is assumed that all terminals are circles with a radius r, and each terminal may broadcast its own position information and motion information. The processing unit 310 may first determine the nearest terminal among the neighboring terminals, as shown by the terminal 410 in FIG. 4, according to the position information, motion information and the like broadcast by the neighboring terminals, and determine a blocked area caused by the nearest terminal, for example, according to the following formula (1):

$$\begin{matrix}arctan \frac{ {y}_{m} - {y}_{n}}{{x}_{m} - {x}_{n}} - arcsin \frac{r}{\sqrt{{\vert {x}_{m} - {x}_{n} \vert}^{2} + {\vert {y}_{m} - {y}_{n} \vert}^{2}}} < {θ}_{m , n}^{\text{?}} < arctan \frac{ {y}_{m} - {y}_{n}}{{x}_{m} - {x}_{n}} + arcsin \frac{r}{\sqrt{{\vert {x}_{m} - {x}_{n} \vert}^{2} + {\vert {y}_{m} - {y}_{n} \vert}^{2}}} & ( 1 ) \\ \text{?} \text{indicates text missing or illegible when filed} & \end{matrix}$$

where xₘ, yₘ are position coordinates of the terminal 300 on the X axis and the Y axis, respectively, and xₙ, yₙ are position coordinates of the terminal 410 on the X axis and the Y axis, respectively. θ [symbol] is an angle at which the terminal 410 blocks the terminal 300, \sqrt{|xₘ−xₙ|²+|yₘ−yₙ|²} is a distance between the center of the terminal 300 and the center of the terminal 410,

$$arctan \frac{ {y}_{m} - {y}_{n}}{{x}_{m} - {x}_{n}}$$

is a position angle (direction) between the center of the terminal 300 and the center of the terminal 410, and

$$arcsin \frac{r}{\sqrt{{\vert {x}_{m} - {x}_{n} \vert}^{2} + {\vert {y}_{m} - {y}_{n} \vert}^{2}}}$$

is an angle difference between the center of the terminal 300 and the boundary and the center of the terminal 410. In FIG. 4, the block area caused by the terminal 410 is shown in a dark gray triangular area.

In addition, the transmitting unit of the terminal 300 may have a specific transmission area, as shown by a light gray triangular area in FIG. 4. In this case, whether the terminal 410 is an obstacle terminal may be further determined according to the transmission area of the transmitting unit of the terminal 300. For example, whether the terminal 410 will be considered as an obstacle terminal is determined according to the following formula (2) or formula (3):

$$\begin{matrix}{\partial }_{m}^{Lo} < arctan \frac{ {y}_{m} - {y}_{n}}{{x}_{m} - {x}_{n}} - arcsin \frac{r}{\sqrt{{\vert {x}_{m} - {x}_{n} \vert}^{2} + {\vert {y}_{m} - {y}_{n} \vert}^{2}}} < {\partial }_{m}^{Up} & ( 2 ) \\ {\partial }_{m}^{Lo} < arctan \frac{ {y}_{m} - {y}_{n}}{{x}_{m} - {x}_{n}} + arcsin \frac{r}{\sqrt{{\vert {x}_{m} - {x}_{n} \vert}^{2} + {\vert {y}_{m} - {y}_{n} \vert}^{2}}} < {\partial }_{m}^{Up} & ( 3 )\end{matrix}$$

where ∂ₘ^{Lo} is a lower limit of the transmission area of the terminal 300, and ∂ₘ^{Up} is a upper limit of the transmission area of the terminal 300.

When a relationship between the terminal 300 and the terminal 410 satisfies the formula (2) or the formula (3), the processing unit 310 determines that the terminal 410 may serve as an obstacle terminal of the terminal 300.

If the terminal 410 may serve as an obstacle terminal of the terminal 300, the processing unit 310 may determine whether links between the terminal 300 and other neighboring terminals are blocked by the terminal 410. For example, the processing unit 310 may determine whether links between the terminal 300 and other neighboring terminals are blocked by the terminal 410 according to the following formulas (5) and (6):

$$\begin{matrix}{θ}_{m , k} = arctan \frac{ {y}_{m} - {y}_{k}}{{x}_{m} - {x}_{k}} ∈ {θ}_{m , n}^{block} & ( 5 ) \\ \sqrt{{\vert {x}_{m} - {x}_{k} \vert}^{2} + {\vert {y}_{m} - {y}_{k} \vert}^{2}} > \sqrt{{\vert {x}_{m} - {x}_{n} \vert}^{2} + {\vert {y}_{m} - {y}_{n} \vert}^{2}} & ( 6 )\end{matrix}$$

where xₖ, yₖ are position coordinates of other neighboring terminals on the X axis and the Y axis, respectively. θ_{m,k} is an angle between the center of the terminal 300 and centers of other neighboring terminals except the terminal 410, \sqrt{|xₘ−xₖ|²+|yₘ−yₖ|²} is a distance between the center of the terminal 300 and centers of other neighboring terminals except the terminal 410.

When relationships between the terminal 300 and other neighboring terminals satisfy the formula (5) and the formula (6), the processing unit 310 determines that the links between the terminal 300 and the other neighboring terminals are blocked by the terminal 410. As shown in FIG. 4, the relationship between the terminal 420 and the terminal 300 satisfies the formula (5) and the formula (6), and the terminal 420 is located in the blocked area caused by the terminal 410, so the link between the terminal 420 and the terminal 300 is blocked by the terminal 410.

Next, the processing unit 310 may select a neighboring terminal that is not blocked and is the second nearest to the terminal 300 among the neighboring terminals, and repeats the above process, until it is determined for each neighboring terminal whether a link between the neighboring terminal and the terminal 300 is blocked. In this way, the information about the unblocked links of the terminal 300 may be obtained.

In addition, the information about the unblocked links of the terminal 300 may also be obtained in other ways. For example, the neighboring terminals may determine the information about the unblocked links relative to the terminal 300, and the terminal 300 may obtain the information about the unblocked links via the receiving unit.

In the case that the link state information may include the information about the unblocked links of the terminal 300, the movement information includes movement information about neighboring terminals corresponding to the respective unblocked links. For example, the movement information may be information about movement speeds, distances and the like of the neighboring terminals. The processing unit 310 may determine the cluster head parameter according to the information about the unblocked links of the terminal 300 and the movement information of the neighboring terminals corresponding to the respective unblocked links.

According to an example of the present disclosure, the cluster head parameter may be a utility function of the maximum duration of unblocked link of the terminal 300. For example, the processing unit 310 may determine the utility function max Uₘ¹ of the maximum duration of unblocked link according to the following formula (7):

$$max {U}_{m}^{1} = {\sum }_{0}^{\vert 𝒩𝔅 {ℒ}_{m} \vert} {U}_{m , i} = {\sum }_{0}^{\vert 𝒩𝔅 {ℒ}_{m} \vert} \frac{{d}_{m , i}^{rel} + {R}_{Tx}}{{v}_{m , i}^{rel}} \qquad ( 7 )$$

where relevant parameters of the terminal 300 itself are represented by a subscript m, [symbol] is the number of the unblocked links of the terminal 300, U_{m,l} is a utility function of duration of a link between the terminal 300 and an unblocked neighboring terminal i, d_{m,i}^{rad} is a relative distance between the terminal 300 and the unblocked neighboring terminal i, R_{T} is a transmission distance of the terminal 300, and v_{m,i}^{rel} is a relative speed between the terminal 300 and the neighboring terminal i.

### Example 2 of Determining the Cluster Head Parameter

According to another example of the present disclosure, the link state information may include signal state information about the respective links of the terminal 300. For example, SNR (Signal-to-Noise Ratio information) may be used to indicate a signal state of a link between the terminal 300 and a neighboring terminal. For example, when SNR of the neighboring terminal is high, it may indicate that a possibility of the link between the neighboring terminal and the terminal 300 being blocked is low. On the contrary, it may indicate that that a possibility of the link between the neighboring terminal and the terminal 300 being blocked is high. In this example, each terminal may broadcast its own position information, movement information (such as speed information, etc.) and SNR information. The terminal 300 may include a receiving unit to receive location information, motion information, SNR information, and the like transmitted by the neighboring terminals. For example, each terminal may periodically measure a SNR state of a link between itself and each neighboring terminal, and broadcast SNR information according to the measured state.

In the case where the link state information may include information about the connection state of all links of the terminal 300, the movement information includes movement information about neighboring terminals corresponding to the respective links. For example, the movement information may be information about movement speeds, distances and the like of the neighboring terminals. The processing unit 310 may determine the cluster head parameter according to the signal state information about the respective links of the terminal 300 and the movement information of the neighboring terminals corresponding to the respective links.

In this example, the cluster head parameter may be a utility function of the maximum duration of all links of the terminal 300. For example, the processing unit 310 may determine the utility function max Uₘ¹′ of the maximum duration of all links according to the following formula (8):

$$max {U}_{m}^{{1}^{′}} = {\sum }_{0}^{\vert {ℒ}_{m} \vert} {U}_{m , i}^{′} = {\sum }_{0}^{\vert {ℒ}_{m} \vert} \frac{( {d}_{m , n}^{rel} + {R}_{Tx} ) {SNR}_{m , n}}{{v}_{mJ}^{rel}} \qquad ( 8 )$$

where relevant parameters of the terminal 300 itself are represented by a subscript m, | [symbol] ₘ| is the number of the links of the terminal 300, is a utility function of duration of a link between the terminal 300 and a neighboring terminal i, d_{m,i}^{rel} is a relative distance between the terminal 300 and the neighboring terminal i, R [symbol] is a transmission distance of the terminal 300, SNR_{m,i} is SNR between the terminal 300 and the neighboring terminal i, and v_{m,i}^{rel} is a relative speed between the terminal 300 and the neighboring terminal i. As described above, each terminal may periodically measure an SNR state of a link between itself and each neighboring terminal, and broadcast SNR information according to the measured state. The processing unit 310 may determine the cluster head parameter by using the latest SNR information received by the terminal 300.

In the above example 1 of determining the cluster head parameter, the description is made by assuming that a terminal is a circle with a radius r as an example, but the present disclosure is not limited thereto. For example, it may also be assumed that a terminal is a rectangle, and the length and width of the rectangle may be determined according to a specific condition of each terminal. Furthermore, blocked areas may be determined according to specific rectangles. In addition, although all unblocked links are described as an example in the above formula (7), alternatively, according to specific requirements, the utility function of the maximum duration of unblocked links may be determined according to a part of the unblocked links that meet the requirements. Similarly, although in the above example 2 of determining the cluster head parameter, all links are described as an example, alternatively, the utility function of the maximum duration of links may be determined according to a part of the links that meet the requirements.

Returning to FIG. 3, after the processing unit 310 determines the cluster head parameter, the transmitting unit 320 may transmit information about the cluster head parameter. For example, the transmitting unit 320 may broadcast information about the cluster head parameter determined by the processing unit 310. The cluster head parameter may be used to determine a cluster head. For example, as described above, according to an example of the present disclosure, the terminal 300 may further include a receiving unit to receive information about cluster head parameters of neighboring terminals transmitted by the neighboring terminals. The processing unit 310 may determine whether the terminal 300 becomes a cluster head according to the cluster head parameter of the terminal 300 determined by the processing unit and the cluster head parameters of the neighboring terminals.

The terminal 300 according to an embodiment of the present disclosure has been described above with reference to FIGS. 3 and 4. In this embodiment, by determining a cluster head parameter based on link state information of links between the terminal 300 and neighboring terminals and movement information about at least a part of the neighboring terminals, influence on cluster head selection by the situation of link unavailability caused by blockage is reduced. In addition, in a further example described in combination with the formula 7 and the formula 8, by determining the cluster head parameter according to the relative movement information between the terminal 300 and the neighboring terminals, influence of each terminal's mobility on cluster head selection in the Internet of Vehicles environment is taken into account, thereby further improving the effectiveness of the cluster head selection.

In addition, according to an example of the present disclosure, when the processing unit 310 determines that the terminal 300 becomes a cluster head, cluster head information is transmitted, so that a neighboring terminal may determine whether to become a member of the terminal 300 according to the cluster head information.

According to another example of the present disclosure, when it is determined that the terminal 300 does not become a cluster head, the receiving unit may receive cluster head information transmitted by a cluster head (i.e., a specific neighboring terminal of the terminal 300). The processing unit 310 may determine whether to join the cluster where the cluster head is located according to movement information corresponding to the cluster head information. For example, the movement information corresponding to the cluster head information may include a relative speed and a relative distance between the terminal 300 and the cluster head.

For example, the processing unit 310 may determine a utility function of the maximum duration of the terminal 300 in the cluster where the cluster head is located according to the following formula (9), and then determine whether to join the cluster where the cluster head is located:

$$max {U}_{i , p}^{2} = \frac{{d}_{p , i}^{rel} + {R}_{TX}}{{v}_{p , i}^{rel}} \qquad ( 9 )$$

where d_{p,i}^{rel} is a relative distance between the terminal 300 and the cluster head p, v_{p,i}^{rel} is a relative speed between the terminal 300 and the cluster head p, and is the transmission distance of the terminal 300.

When the maximum duration of the terminal 300 in the cluster where the cluster head is located satisfies a predetermined condition, the processing unit 310 may determine to join the cluster where the cluster head is located, that is, become a member of the cluster head. On the contrary, the processing unit 310 may determine not to join the cluster where the cluster head is located. That is, a candidate member may determine whether to join the cluster where the cluster head is located according to relative movement information with the cluster head, and therefore, compared with the existing clustering methods, once the candidate member determines to join the cluster, the time it stays in the cluster may be longer, thereby avoiding frequent switching of the terminal among multiple clusters.

According to another example of the present disclosure, if the processing unit 310 determines that the terminal 300 becomes a cluster head, the transmitting unit 320 may also transmit maintenance information, and the receiving unit receives feedback information for the maintenance information from members of the cluster to check a state of its members. For example, the processing unit 310 may determine the number of members transmitting feedback information, and when the number of members transmitting feedback information is less than a predetermined number, the processing unit 310 may determine to disband the cluster where the terminal 300 is located.

The exemplary situation in which, when forming a new cluster, the terminal according to the present disclosure determines a cluster head parameter, select a cluster head, and determines whether to join the newly formed cluster is describe above. In the Internet of Vehicles, there may also be a situation where a newly-appearing terminal wishes to join an already formed cluster. Similar to the situation of forming a new cluster, for the situation where a newly-appearing terminal wishes to join an already formed cluster, it is also desirable to propose a terminal and a member invitation method to improve the problem brought by the use of millimeter waves for communication in the Internet of Vehicles technology.

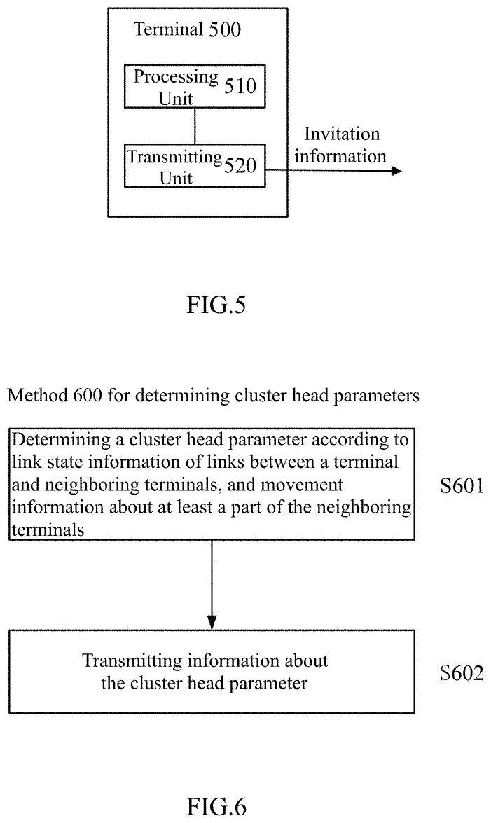

A terminal 500 according to another embodiment of the present disclosure will be described below with reference to FIG. 5. As shown in FIG. 5, the terminal 500 may include a processing unit 510 and a transmitting unit 520. According to an example of the present disclosure, the terminal 500 may be a cluster head of an already formed cluster.

The processing unit 510 may determine whether to transmit invitation information to a newly-appearing neighboring terminal according to link state information of links between the newly-appearing neighboring terminal and members of the cluster where the terminal 500 is located. For example, the link state information of the links between the neighboring terminal and the members of the cluster where the terminal 500 is located may be information directly or indirectly indicating a state of a link between the neighboring terminal and each member of the cluster where the terminal 500 is located being blocked or not being blocked. Examples in which the processing unit 510 determines whether to transmit invitation information to a newly-appearing neighboring terminal will be further described below, in conjunction with specific examples of the link state information of the links between the newly-appearing neighboring terminal and the members of the cluster where the terminal 500 is located.

### Example 1 of Determining Whether to Transmit Invitation Information to a Newly-Appearing Neighboring Terminal

According to an example of the present disclosure, the link state information of the links between the newly-appearing neighboring terminal and the members of the cluster where the terminal 500 is located may include information about unblocked links between the newly-appearing neighboring terminal and the members of the cluster where the terminal 500 is located, and information about blocked links between the newly-appearing neighboring terminal and the members of the cluster where the terminal is located. For example, the newly-appearing neighboring terminal may broadcast its own position information and motion information (such as speed information, etc.). How to determine blocked links or unblocked links has been described above in detail in conjunction with FIG. 4 and formulas (1)-(6), and thus will not be described in detail again herein.

The processing unit 510 may determine whether to transmit invitation information to the newly-appearing neighboring terminal according to the number of unblocked links and blocked links between the newly-appearing neighboring terminal and the members of the cluster where the terminal 500 is located. For example, the processing unit 510 may determine a utility function of a ratio of the number of unblocked links to the total number of links between the members of the cluster according to the following formula (10):

$$max {U}_{{h}_{j}}^{3} = \frac{{n}_{Nblock}^{}}{{n}_{block}^{} + {n}_{Nblock}^{}} \qquad ( 10 )$$

where hⱼ is the cluster where the terminal 500 is located and is numbered j, n [symbol] is the number of unblocked links between the neighboring terminal and the members of the cluster where the terminal 500 is located, n [symbol] +n [symbol] is the total number of links between the neighboring terminal and the members of the cluster where the terminal 500 is located. When the ratio of the number of unblocked links to the total number of links satisfies a predetermined condition, the processing unit 510 may determine whether to transmit invitation information to the newly-appearing neighboring terminal.

### Example 2 of Determining Whether to Transmit Invitation Information to a Newly-Appearing Neighboring Terminal

According to an example of the present disclosure, the link state information of the links between the newly-appearing neighboring terminal and the members of the cluster where the terminal 500 is located may include signal state information about the links between the newly-appearing neighboring terminal and the members of the cluster where the terminal 500 is located. For example, the signal state information about the links between the newly-appearing neighboring terminal and the members of the cluster where the terminal 500 is located may be indicated by using SNR (Signal-to-Noise Ratio information). In this example, each terminal may broadcast its own position information, motion information (such as speed information, etc.) and SNR information.

The processing unit 510 may determine whether to transmit invitation information to the newly-appearing neighboring terminal according to a signal state of the links between the newly-appearing neighboring terminal and the members of the cluster where the terminal 500 is located. For example, the processing unit 510 may determine a max utility function of the maximum SNR of the links between the newly-appearing neighboring terminal and the respective members of the cluster where the terminal 500 is located according to the following formula (11):

$${\sum }_{0}^{\vert {ℒ}_{m} \vert} {SNR}_{{h}_{j} , i} \qquad ( 11 )$$

where is SNRₕ_{ⱼ}_{,i} of a link between the newly-appearing neighboring terminal and a member of the cluster hⱼ where the terminal 500 is located.

Returning to FIG. 5, when it is determined to transmit invitation information to the newly-appearing neighboring terminal, the transmitting unit 520 may transmit the invitation information. For example, the transmitting unit 520 may transmit cluster head information. The newly-appearing neighboring terminal may determine whether to join the cluster where the cluster head is located according to movement information corresponding to the cluster head information. For example, the newly-appearing neighboring terminal may determine the maximum duration of the terminal in the cluster where the cluster head is located according to the method described above in conjunction with the formula (9), and then determine whether to join the cluster where the cluster head is located.

The terminal 500 according to another embodiment of the present disclosure is described above with reference to FIG. 5. In this embodiment, by determining whether to transmit invitation information to a newly-appearing neighboring terminal based on link state information of links between the newly-appearing neighboring terminal and members of the cluster where the terminal 500 is located, influence of blockage and other factors that may be brought by the newly-appearing neighboring terminals may be reduced.

A method 600 for determining cluster head parameters according to an embodiment of the present disclosure will be described below with reference to FIG. 6. FIG. 6 depicts a schematic flowchart of the method 600 for determining cluster head parameters according to an embodiment of the present disclosure. The method 600 for determining cluster head parameters corresponds to the terminals according to an embodiment of the present disclosure described above in conjunction with FIG. 3 and FIG. 4, and therefore, detailed description of the same content is omitted herein for the sake of simplicity.

The method 600 for determining cluster head parameters may be applied in a terminal. As shown in FIG. 6, in step S601, a cluster head parameter may be determined according to link state information of links between the terminal and neighboring terminals, and movement information about at least a part of the neighboring terminals. Specifically, the link state information may be information indicating a connection state of the links between the terminal and the neighboring terminals. For example, the link state information may be information that directly or indirectly indicates the state of the links being blocked or not being blocked. In addition, according to an example of the present disclosure, the movement information may include relative information between the terminal and the neighboring terminals. For example, the movement information may include relative distances, relative speeds, relative positions and the like between the terminal and the neighboring terminals. According to another example of the present disclosure, the movement information is associated with the link state information. For example, when the link state information indicates an unblocked link, the movement information may include movement information of a neighboring terminal on the unblocked link. As another example, when the link state information relates to the connection state of all links of the terminal, the movement information may include movement information of neighboring terminals on all the links. For example, in step S601, the cluster head parameter is determined according to the example 1 of determining the cluster head parameter and the example 2 of determining the cluster head parameter.

Then, in step S602, information about the cluster head parameter may be transmitted. For example, information about the determined cluster head parameter may be broadcast. The cluster head parameter may be used to determine a cluster head. For example, the method for determining cluster head parameters may further include receiving information about cluster head parameters of neighboring terminals transmitted by the neighboring terminals, and determining whether the terminal becomes a cluster head according to the determined cluster head parameter of the terminal and the cluster head parameters of the neighboring terminals.

The method 600 for determining cluster head parameters according to an embodiment of the present disclosure has been described above with reference to FIG. 6. In this embodiment, by determining a cluster head parameter based on link state information of links between a terminal and neighboring terminals and movement information about at least a part of the neighboring terminals, influence on cluster head selection by the situation of link unavailability caused by blockage is reduced. According to a further example of the above method, by determining the cluster head parameter according to the relative movement information between the terminal and the neighboring terminals, influence of each terminal's mobility on cluster head selection in the Internet of Vehicles environment is taken into account, thereby further improving the effectiveness of the cluster head selection.

In addition, according to an example of the present disclosure, the method 600 for determining cluster head parameters may further include: transmitting cluster head information when it is determined that the terminal becomes a cluster head, so that a neighboring terminal may determine whether to become a member of the terminal according to the cluster head information.

According to another example of the present disclosure, the method 600 for determining cluster head parameters may further include: when it is determined that the terminal does not become a cluster head, receiving cluster head information transmitted by a cluster head, and determining whether to join the cluster where the cluster head is located according to movement information corresponding to the cluster head information. For example, the movement information corresponding to the cluster head information may include a relative speed and a relative distance between the terminal and the cluster head. For example, as described above in conjunction with the formula (9), the maximum duration of the terminal in the cluster where the cluster head is located may be determined, and then whether to join the cluster where the cluster head is located is determined. Thus, a candidate member may determine whether to join the cluster where the cluster head is located according to relative movement information with the cluster head, and therefore, compared with the existing clustering methods, once the candidate member determines to join the cluster, the time it stays in the cluster may be longer, thereby avoiding frequent switching of the terminal among multiple clusters.

According to another example of the present disclosure, if it is determined that the terminal becomes a cluster head, the method 600 for determining cluster head parameters may further include transmitting maintenance information, and receiving feedback information for the maintenance information from members of the cluster to check a state of its members. For example, the number of members transmitting feedback information may be determined, and when the number of members transmitting feedback information is less than a predetermined number, it may be determined to disband the cluster where the terminal is located.

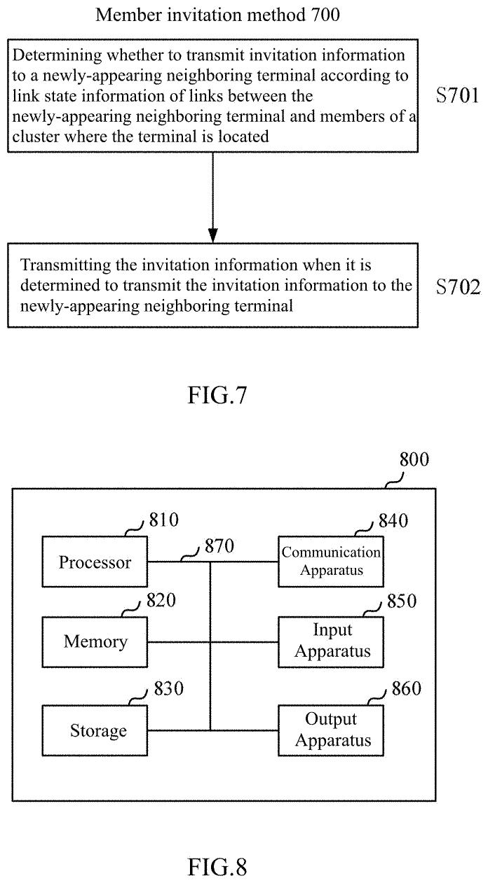

A member invitation method 700 according to an embodiment of the present disclosure when a newly-appearing terminal wishes to join an already formed cluster will be described below with reference to FIG. 7. FIG. 7 depicts a schematic flowchart of a member invitation method 700 according to an embodiment of the present disclosure. The member invitation method 700 corresponds to the terminal according to an embodiment of the present disclosure described above in conjunction with FIG. 5, and therefore, detailed description of the same content is omitted herein for the sake of simplicity.

The member invitation method 700 may be applied in a terminal. According to an example of the present disclosure, the terminal may be a cluster head of an already formed cluster. As shown in FIG. 7, in step S701, whether to transmit invitation information to a newly-appearing neighboring terminal may be determined according to link state information of links between the newly-appearing neighboring terminal and members of the cluster where the terminal is located. For example, the link state information of the links between the neighboring terminal and the members of the cluster where the terminal is located may be information directly or indirectly indicating a state of a link between the neighboring terminal and each member of the cluster where the terminal is located being blocked or not being blocked. For example, in step S701, whether to transmit invitation information to a newly-appearing neighboring terminal may be determined according to the example 1 of determining whether to transmit invitation information to a newly-appearing neighboring terminal, and the example 2 of determining whether to transmit invitation information to a newly-appearing neighboring terminal.

Then, in step S702, when it is determined to transmit invitation information to the newly-appearing neighboring terminal, the invitation information may be transmitted. For example, cluster head information may be transmitted in step S702. The newly-appearing neighboring terminal may determine whether to join the cluster where the cluster head is located according to movement information corresponding to the cluster head information. For example, the newly-appearing neighboring terminal may determine the maximum duration of the terminal in the cluster where the cluster head is located according to the method described above in conjunction with the formula (9), and then determine whether to join the cluster where the cluster head is located.

The member invitation method 700 according to an embodiment of the present disclosure is described above with reference to FIG. 7. In this embodiment, by determining whether to transmit invitation information to a newly-appearing neighboring terminal based on link state information of links between the newly-appearing neighboring terminal and members of the cluster where the terminal 500 is located, influence of blockage and other factors that may be brought by the newly-appearing neighboring terminals may be reduced.

### <Hardware Structure>

In addition, block diagrams used in the description of the above embodiments illustrate blocks in units of functions. These functional blocks (structural blocks) may be implemented in arbitrary combination of hardware and/or software. Furthermore, means for implementing respective functional blocks is not particularly limited. That is, the respective functional blocks may be implemented by one apparatus that is physically and/or logically jointed; or more than two apparatuses that are physically and/or logically separated may be directly and/or indirectly connected (e.g. via wire and/or wireless), and the respective functional blocks may be implemented by these apparatuses.

For example, a terminal in an embodiment of the present disclosure may function as a computer that executes the processes of the wireless communication method of the present disclosure. FIG. 8 is a schematic diagram of a hardware structure of a device 800 (terminal) involved in an embodiment of the present disclosure. The above device 800 (terminal) may be constituted as a computer apparatus that physically comprises a processor 810, a memory 820, a storage 830, a communication apparatus 840, an input apparatus 850, an output apparatus 860, a bus 870 and the like

In addition, in the following description, terms such as “apparatus” may be replaced with circuits, devices, units, and the like. The hardware structure of the user terminal and the base station may include one or more of the respective apparatuses shown in the figure, or may not include a part of the apparatuses.

For example, only one processor 810 is illustrated, but there may be multiple processors. Furthermore, processes may be performed by one processor, or processes may be performed by more than one processor simultaneously, sequentially, or by other methods. In addition, the processor 810 may be installed by more than one chip.

Respective functions of any of the device 800 may be implemented, for example, by reading specified software (program) on hardware such as the processor 810 and the memory 820, so that the processor 810 performs computations, controls communication performed by the communication apparatus 840, and controls reading and/or writing of data in the memory 820 and the storage 830.

The processor 810, for example, operates an operating system to control the entire computer. The processor 810 may be constituted by a Central Processing Unit (CPU), which includes interfaces with peripheral apparatuses, a control apparatus, a computing apparatus, a register and the like. For example, the determining unit, the adjusting unit and the like described above may be implemented by the processor 810.

In addition, the processor 810 reads programs (program codes), software modules and data from the storage 830 and/or the communication apparatus 840 to the memory 820, and execute various processes according to them. As for the program, a program causing computers to execute at least a part of the operations described in the above embodiments may be employed. For example, the processing unit of the terminal 300 or the terminal 500 may be implemented by a control program stored in the memory 820 and operated by the processor 810, and other functional blocks may also be implemented similarly.

The memory 820 is a computer-readable recording medium, and may be constituted, for example, by at least one of a Read Only Memory (ROM), an Erasable Programmable ROM (EPROM), an Electrically EPROM (EEPROM), a Random Access Memory (RAM) and other appropriate storage media. The memory 820 may also be referred to as a register, a cache, a main memory (a main storage apparatus) and the like. The memory 820 may store executable programs (program codes), software modules and the like for implementing a method involved in an embodiment of the present disclosure.

The storage 830 is a computer-readable recording medium, and may be constituted, for example, by at least one of a flexible disk, a Floppy® disk, a magneto-optical disk (e.g., a Compact Disc ROM (CD-ROM) and the like), a digital versatile disk, a Blu-ray® disk, a removable disk, a hard driver, a smart card, a flash memory device (e.g., a card, a stick and a key driver), a magnetic stripe, a database, a server, and other appropriate storage media. The storage 830 may also be referred to as an auxiliary storage apparatus.

The communication apparatus 840 is a hardware (transceiver device) performing communication between computers via a wired and/or wireless network, and is also referred to as a network device, a network controller, a network card, a communication module and the like, for example. The communication device 840 may include a high-frequency switch, a duplexer, a filter, a frequency synthesizer and the like to implement, for example, Frequency Division Duplex (FDD) and/or Time Division Duplex (TDD). For example, the transmitting unit, the receiving unit and the like described above may be implemented by the communication apparatus 840.

The input apparatus 850 is an input device (e.g., a keyboard, a mouse, a microphone, a switch, a button, a sensor and the like) that receives input from the outside. The output apparatus 860 is an output device (e.g., a display, a speaker, a Light Emitting Diode (LED) light and the like) that performs outputting to the outside. In addition, the input apparatus 850 and the output apparatus 860 may also be an integrated structure (e.g., a touch screen).

Furthermore, the respective apparatuses such as the processor 810 and the memory 820 are connected by the bus 870 that communicates information. The bus 870 may be constituted by a single bus or by different buses between the apparatuses.

Furthermore, the base station and the user terminal may comprise hardware such as a microprocessor, a Digital Signal Processor (DSP), an Application Specified Integrated Circuit (ASIC), a Programmable Logic Device (PLD), a Field Programmable Gate Array (FPGA), etc., and the hardware may be used to implement a part of or all of the respective functional blocks. For example, the processor 810 may be installed by at least one of these hardware.

(Variations)

In addition, the terms illustrated in the present specification and/or the terms required for understanding of the present specification may be substituted with terms having the same or similar meaning. For example, a channel and/or a symbol may also be a signal (signaling). Furthermore, the signal may be a message. A reference signal may be abbreviated as an “RS”, and may also be referred to as a pilot, a pilot signal and so on, depending on the standard applied. Furthermore, a component carrier (CC) may also be referred to as a cell, a frequency carrier, a carrier frequency, and the like.

Furthermore, the information, parameters and so on described in this specification may be represented in absolute values or in relative values with respect to specified values, or may be represented by other corresponding information. For example, radio resources may be indicated by specified indexes. Furthermore, formulas and the like using these parameters may be different from those explicitly disclosed in this specification.

The names used for the parameters and the like in this specification are not limited in any respect. For example, since various channels (Physical Uplink Control Channels (PUCCHs), Physical Downlink Control Channels (PDCCHs), etc.) and information elements may be identified by any suitable names, the various names assigned to these various channels and information elements are not limitative in any respect.

The information, signals and the like described in this specification may be represented by using any one of various different technologies. For example, data, instructions, commands, information, signals, bits, symbols, chips, etc. possibly referenced throughout the above description may be represented by voltages, currents, electromagnetic waves, magnetic fields or particles, optical fields or photons, or any combination thereof.

In addition, information, signals and the like may be output from higher layers to lower layers and/or from lower layers to higher layers. Information, signals and the like may be input or output via a plurality of network nodes.

The information, signals and the like that are input or output may be stored in a specific location (for example, in a memory), or may be managed in a control table. The information, signals and the like that are input or output may be overwritten, updated or appended. The information, signals and the like that are output may be deleted. The information, signals and the like that are input may be transmitted to other apparatuses.

Reporting of information is by no means limited to the manners/embodiments described in this specification, and may be implemented by other methods as well. For example, reporting of information may be implemented by using physical layer signaling (for example, downlink control information (DCI), uplink control information (UCI)), higher layer signaling (for example, RRC (Radio Resource Control) signaling, broadcast information (master information blocks (MIBs), system information blocks (SIBs), etc.), MAC (Medium Access Control) signaling), other signals or combinations thereof.

In addition, physical layer signaling may also be referred to as L1/L2 (Layer 1/Layer 2) control information (L1/L2 control signals), L1 control information (L1 control signal) and the like. Furthermore, RRC signaling may also be referred to as RRC messages, for example, RRC connection setup messages, RRC connection reconfiguration messages, and so on. Furthermore, MAC signaling may be reported by using, for example, MAC control elements (MAC CEs).

Furthermore, notification of prescribed information (for example, notification of “being X”) is not limited to being performed explicitly, and may be performed implicitly (for example, by not performing notification of the prescribed information or by notification of other information).

Decision may be performed by a value (0 or 1) represented by 1 bit, or by a true or false value (Boolean value) represented by TRUE or FALSE, or by a numerical comparison (e.g., comparison with a prescribed value).

Software, whether referred to as “software”, “firmware”, “middleware”, “microcode” or “hardware description language”, or called by other names, should be interpreted broadly to mean instructions, instruction sets, code, code segments, program codes, programs, subprograms, software modules, applications, software applications, software packages, routines, subroutines, objects, executable files, execution threads, procedures, functions and so on.

In addition, software, commands, information, etc. may be transmitted and received via a transport medium. For example, when software is transmitted from web pages, servers or other remote sources using wired technologies (coaxial cables, fibers, twisted pairs, Digital Subscriber Lines (DSLs), etc.) and/or wireless technologies (infrared ray, microwave, etc.), these wired technologies and/or wireless technologies are included in the definition of the transport medium.

The terms “system” and “network” used in this specification may be used interchangeably.

In this specification, terms like “Base Station (BS)”, “wireless base station”, “eNB”, “gNB”, “cell”, “sector”, “cell group”, “carrier” and “component carrier” may be used interchangeably. A base station is sometimes referred to as terms such as a fixed station, a NodeB, an eNodeB (eNB), an access point, a transmitting point, a receiving point, a femto cell, a small cell and the like.

A base station is capable of accommodating one or more (for example, three) cells (also referred to as sectors). In the case where the base station accommodates a plurality of cells, the entire coverage area of the base station may be divided into a plurality of smaller areas, and each smaller area may provide communication services by using a base station sub-system (for example, a small base station for indoor use (a Remote Radio Head (RRH)). Terms like “cell” and “sector” refer to a part of or an entirety of the coverage area of a base station and/or a sub-system of the base station that provides communication services in this coverage.

In this specification, terms such as “Mobile Station (MS)”, “user terminal”, “User Equipment (UE)”, and “terminal” may be used interchangeably. The mobile station is sometimes referred by those skilled in the art as a user station, a mobile unit, a user unit, a wireless unit, a remote unit, a mobile device, a wireless device, a wireless communication device, a remote device, a mobile user station, an access terminal, a mobile terminal, a wireless terminal, a remote terminal, a handset, a user agent, a mobile client, a client, or some other appropriate terms.

Furthermore, a wireless base station in this specification may also be replaced with a user terminal. For example, for a structure in which communication between a wireless base station and a user terminal is replaced with communication between a plurality of user terminals (Device-to-Device, D2D), the respective manners/embodiments of the present disclosure may also be applied. At this time, functions provided by the first communication device and the second communication device of the above device 800 may be regarded as functions provided by a user terminal. Furthermore, the words “uplink” and “downlink” may also be replaced with “side”. For example, an uplink channel may be replaced with a side channel.

Also, a user terminal in this specification may be replaced with a wireless base station. At this time, functions provided by the above user terminal may be regarded as functions provided by the first communication device and the second communication device.

In this specification, specific actions configured to be performed by the base station sometimes may be performed by its upper nodes in certain cases. Obviously, in a network composed of one or more network nodes having base stations, various actions performed for communication with terminals may be performed by the base stations, one or more network nodes other than the base stations (for example, Mobility Management Entities (MMEs), Serving-Gateways (S-GWs), etc., may be considered, but not limited thereto)), or combinations thereof.

The respective manners/embodiments described in this specification may be used individually or in combinations, and may also be switched and used during execution. In addition, orders of processes, sequences, flow charts and so on of the respective manners/embodiments described in this specification may be re-ordered as long as there is no inconsistency. For example, although various methods have been described in this specification with various units of steps in exemplary orders, the specific orders as described are by no means limitative.

The manners/embodiments described in this specification may be applied to systems that utilize Long Term Evolution (LTE), Advanced Long Term Evolution (LTE-A, LTE-Advanced), Beyond Long Term Evolution (LTE-B, LTE-Beyond), the super 3rd generation mobile communication system (SUPER 3G), Advanced International Mobile Telecommunications (IMT-Advanced), the 4th generation mobile communication system (4G), the 5th generation mobile communication system (5G), Future Radio Access (FRA), New Radio Access Technology (New-RAT), New Radio (NR), New radio access (NX), Future generation radio access (FX), Global System for Mobile communications (GSM®), Code Division Multiple Access 3000 (CDMA 3000), Ultra Mobile Broadband (UMB), IEEE 920.11 (Wi-Fi®), IEEE 920.16 (WiMAX®), IEEE 920.20, Ultra-Wide Band (UWB), Bluetooth® and other appropriate wireless communication methods, and/or next-generation systems that are enhanced based on them.

Terms such as “based on” as used in this specification do not mean “based on only”, unless otherwise specified in other paragraphs. In other words, terms such as “based on” mean both “based on only” and “at least based on.”

Any reference to units with designations such as “first”, “second” and so on as used in this specification does not generally limit the quantity or order of these units. These designations may be used in this specification as a convenient method for distinguishing between two or more units. Therefore, reference to a first unit and a second unit does not imply that only two units may be employed, or that the first unit must precedes the second unit in several ways.

Terms such as “deciding (determining)” as used in this specification may encompass a wide variety of actions. The “deciding (determining)” may regard, for example, calculating, computing, processing, deriving, investigating, looking up (e.g., looking up in a table, a database or other data structures), ascertaining, etc. as performing the “deciding (determining)”. In addition, the “deciding (determining)” may also regard receiving (e.g., receiving information), transmitting (e.g., transmitting information), inputting, outputting, accessing (e.g., accessing data in a memory), etc. as performing the “deciding (determining)”. In addition, the “deciding (determining)” may further regard resolving, selecting, choosing, establishing, comparing, etc. as performing the “deciding (determining)”. That is to say, the “deciding (determining)” may regard certain actions as performing the “deciding (determining)”.

As used herein, terms such as “connected”, “coupled”, or any variation thereof mean any direct or indirect connection or coupling between two or more units, and may include the presence of one or more intermediate units between two units that are “connected” or “coupled” to each other. Coupling or connection between the units may be physical, logical or a combination thereof. For example, “connection” may be replaced with “access.” As used in this specification, two units may be considered as being “connected” or “coupled” to each other by using one or more electrical wires, cables and/or printed electrical connections, and, as a number of non-limiting and non-inclusive examples, by using electromagnetic energy having wavelengths in the radio frequency region, microwave region and/or optical (both visible and invisible) region.

When terms such as “including”, “comprising” and variations thereof are used in this specification or the claims, these terms, similar to the term “having”, are also intended to be inclusive. Furthermore, the term “or” as used in this specification or the claims is not an exclusive or.

Although the present disclosure has been described above in detail, it should be obvious to a person skilled in the art that the present disclosure is by no means limited to the embodiments described in this specification. The present disclosure may be implemented with various modifications and alterations without departing from the spirit and scope of the present disclosure defined by the recitations of the claims. Consequently, the description in this specification is for the purpose of illustration, and does not have any limitative meaning to the present disclosure.

1. A terminal, comprising:
a processing unit configured to determine a cluster head parameter according to link state information of links between the terminal and neighboring terminals, and movement information about at least a part of the neighboring terminals; and
a transmitting unit configured to transmit information about the cluster head parameter.

2. The terminal of claim 1, further comprising:
a receiving unit receiving information about cluster head parameters of the neighboring terminals transmitted by the neighboring terminals, wherein
the processing unit is further configured to determine whether the terminal becomes a cluster head according to the cluster head parameter determined by the processing unit and the cluster head parameters of the neighboring terminals.

3. The terminal of claim 1, wherein
the link state information includes information about unblocked links of the terminal; and
the movement information includes movement information about neighboring terminals corresponding to the respective unblocked links.

4. The terminal of claim 1, wherein
the link state information includes signal state information about the respective links of the terminal; and
the movement information includes movement information about neighboring terminals corresponding to the respective links.

5. The terminal of claim 1, wherein
the movement information includes relative information between the terminal and the neighboring terminals.

6. The terminal of claim 2, wherein
the receiving unit is further configured to receive cluster head information transmitted by a cluster head when the terminal does not become a cluster head; and
the processing unit is further configured to determine whether to join a cluster where the cluster head is located according to movement information corresponding to the cluster head information.

7. A terminal, comprising:
a processing unit configured to determine whether to transmit invitation information to a newly-appearing neighboring terminal according to link state information of links between the newly-appearing neighboring terminal and members of a cluster where the terminal is located; and
a transmitting unit configured to transmit the invitation information when it is determined to transmit the invitation information to the newly-appearing neighboring terminal.

8. The terminal of claim 7, wherein
the link state information includes: information about unblocked links between the newly-appearing neighboring terminal and the members of the cluster where the terminal is located, and information about blocked links between the newly-appearing neighboring terminal and the members of the cluster where the terminal is located.

9. The terminal of claim 7, wherein
the link state information includes: signal state information about the links between the newly-appearing neighboring terminal and the members of the cluster where the terminal is located.

10. A method for determining cluster head parameters, comprising:
determining a cluster head parameter according to link state information of links between a terminal and neighboring terminals, and movement information about at least a part of the neighboring terminals; and
transmitting information about the cluster head parameter.
